(19) United States
(12) Patent Application Publication
(10) Pub. No.: US 2026/0228722 A1
(43) Pub. Date: Aug. 6, 2026

(54) NFC DEVICE CAPABLE OF AUTHENTICATING RECEIVED MESSAGE, METHOD THEREOF, AND NFC SELF-PAYMENT METHOD USING THE SAME

(71) Applicant: 3A LOGICS Co., LTD., Seongnam-si (KR)

(72) Inventors: SungWan KIM, Seongnam-si (KR); HyeongKyu CHOI, Seongnam-si (KR)

(73) Assignee: 3A LOGICS Co., LTD., Seongnam-si (KR)

(21) Appl. No.: 19/089,610

(22) Filed: Mar. 25, 2025

(30) Foreign Application Priority Data
Feb. 6, 2025 (KR) 10-2025-0014864
Feb. 6, 2025 (KR) 10-2025-0014875

(51) Int. Cl. G06Q 20/38; G06Q 20/32; H04W 4/80

(52) U.S. Cl. CPC G06Q 20/3829; G06Q 20/3278; H04W 4/80

(57) ABSTRACT

Provided is an NFC tag, including a memory configured to store a message and a key, and a logic circuit configured to receive the message and the key and determine whether each of lengths of the message and the key is an integer multiple of a processing unit, in which, when the length of the message is not m-times the processing unit, the logic circuit generates a correction message including m-processing units by inserting first padding bits into the message so that the length of the message becomes the m-times the processing unit, generates, when the length of the key is not n-times the processing unit, a correction key including n-processing units by inserting second padding bits into the key so that the length of the key becomes the n-times the processing unit, and divides the correction key into a first part and a second part, the processing unit is k bits, each of m and n is a natural number equal to or greater than one, and k is a natural number equal to or greater than two.

### CROSS-REFERENCE TO RELATED APPLICATIONS

This application claims priority under 35 U.S.C. § 119 from Korean Patent Application No. 10-2025-0014864, filed on Feb. 6, 2025, and No. 10-2025-0014875, filed on Feb. 6, 2025 the disclosure of each of which is hereby incorporated by reference in its entirety.

### BACKGROUND

The present invention relates to a Near Field Communication (NFC) device, and more particularly, to an NFC device capable of authenticating received messages using a lightweight ciper-based message authentication code algorithm proposed in the present invention, an operating method thereof, and an NFC self-payment method using the same.

NFC devices are devices that use wireless technology for short-range communication. NFC technology can transmit data over a short distance of less than 10 cm, and is used in various fields such as smartphones, cards, payment systems, or electronic devices.

Message Authentication Code (MAC) is a cryptographic method used to verify the integrity and authentication of data. MAC ensures that a message has not been changed when it is transmitted, so that the sender and receiver of the message may trust it. MAC is used in encrypted communications and plays an important role in preventing hackers from manipulating the data while it is being transmitted.

### SUMMARY

An object of the present invention is to provide an NFC device, an operating method thereof, and an NFC self-payment method using the same, which can authenticate a received message by performing simple operations, such as an XOR operation, a circular shift operation, and a modulo operation, instead of using an advanced encryption standard (AES) algorithm or a data encryption standard (DES) algorithm to ensure an integrity of a message exchanged between a transmitter and a receiver, while ensuring the integrity.

An exemplary embodiment of the present invention is directed to an Near Field Communication (NFC) tag, including a memory configured to store a message and a key, and a logic circuit configured to receive the message and the key and determine whether each of lengths of the message and the key is an integer multiple of a processing unit, wherein the logic circuit configured to generate, when the length of the message is not m-times the processing unit, a correction message including m-processing units by inserting first padding bits into the message so that the length of the message becomes the m-times the processing unit, generates, when the length of the key is not n-times the processing unit, a correction key including n-processing units by inserting second padding bits into the key so that the length of the key becomes the n-times the processing unit, and divide the correction key into a first part and a second part, wherein the processing unit is k bits, each of m and n is a natural number equal to or greater than one, and k is a natural number equal to or greater than two.

Another exemplary embodiment of the present invention is directed to an Near Field Communication (NFC) reader, including a memory configured to store a key, an antenna configured to receive a message transmitted from an NFC tag and a first message authentication code (MAC), a communication circuit configured to receive the message and the first MAC from the antenna, and a processor configured to receive the message and the key and determine whether each of lengths of the message and the key is an integer multiple of a processing unit, wherein the processor configured to generate, when the length of the message is not m-times the processing unit, a correction message including m-processing units by inserting first padding bits into the message so that the length of the message becomes the m-times the processing unit, generates, when the length of the key is not n-times the processing unit, a correction key including n-processing units by inserting second padding bits into the key so that the length of the key becomes the n-times the processing unit, and divide the correction key into a first part and a second part, wherein the processing unit is k bits, each of m and n is a natural number equal to or greater than one, and k is a natural number equal to or greater than two.

Still another exemplary embodiment of the present invention is directed to a method of authenticating a message of an Near Field Communication (NFC) tag using an NFC reader storing a key, including receiving, by the NFC reader, the message and a first message authentication code (MAC) from the NFC tag when the NFC tag is tagged by the NFC reader, generating, by the NFC reader, a correction message including m-processing units by inserting first padding bits into the message so that a length of the message becomes m-times the processing unit, generating, by the NFC reader, a correction key including n-processing units by inserting second padding bits into the key so that a length of the key becomes n-times the processing unit, and dividing, by the NFC reader, the correction key into a first part and a second part, in which the processing unit is k bits, each of m and n is a natural number equal to or greater than one, and k is a natural number equal to or greater than two.

Still another exemplary embodiment of the present invention is directed to an Near Field Communication (NFC) self-checkout method using an NFC system, in which the NFC system includes a first NFC tag that stores a first key, a first message, and a first message authentication code (MAC) and is attached to a product, a second NFC tag that stores a second key identical to the first key, a second message, and a second MAC, and is installed in a store, an NFC mobile device that includes a processor executing a shopping cart program for NFC self-checkout; and web server that stores a third key identical to the first key, and the NFC self-checkout method includes receiving, by the NFC mobile device, the second message including a web address corresponding to the web server and store information and the second MAC from the second NFC tag and transmits the second message and the second MAC to the web server when the second NFC tag is tagged by the NFC mobile device, generating, by the web server, a third MAC by applying the third key to the second message, comparing, by the web server, the second MAC and the third MAC, and controlling the NFC mobile device so that the shopping cart program is executed when the second MAC and the third MAC are identical.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of an NFC system according to an embodiment of the present invention;

FIG. 2 is a block diagram of a first NFC tag attached to a product shown in FIG. 1;

FIG. 3 is a block diagram of a second NFC tag installed in a store shown in FIG. 1;

FIG. 4A is a flowchart for describing NFC self-checkout methods performed using the NFC system shown in FIG. 1;

FIG. 4B is a flowchart for describing NFC self-checkout methods performed using the NFC system shown in FIG. 1;

FIG. 5 is an example of graphical user interfaces of a shopping cart displayed on an NFC mobile device shown in FIG. 1.

FIG. 6 is a conceptual diagram for describing a method of authenticating a message of a transmitter using a receiver shown in FIG. 1.

FIG. 7 is a conceptual diagram for describing a process of generating a correction message by inserting first padding bits into a message.

FIG. 8 is a conceptual diagram for describing a process of generating a correction key by inserting second padding bits into a key.

FIG. 9 is a conceptual diagram for describing a process of generating a correction key by inserting third padding bits into the key when a length of the key is longer than a length of the correction message.

FIG. 10 is a conceptual diagram for describing a process of generating a merged message by merging a portion of the correction key into the correction message.

FIG. 11 is a conceptual diagram for describing a process of generating MAC by the transmitter or receiver of FIG. 6.

FIG. 12 is a conceptual diagram for describing a shift direction and the number of shifts used in the process of generating MAC in FIG. 11.

### DETAILED DESCRIPTION OF THE EMBODIMENTS

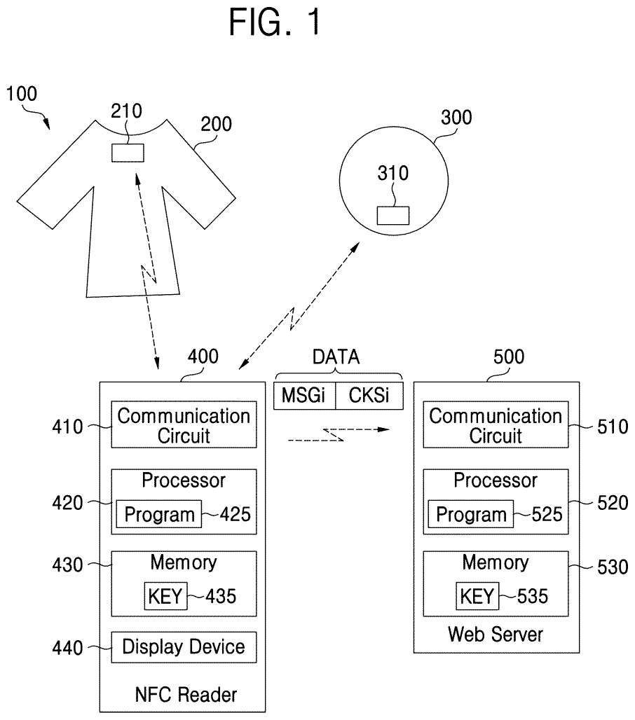

FIG. 1 is a block diagram of an NFC system according to an embodiment of the present invention. Referring to FIG. 1, an NFC system (or an NFC self-checkout system) 100 includes a product 200 to which a first NFC tag 210 is attached, a second NFC tag 310 attached to a self-checkout counter 300 of a store selling the product 200, an NFC mobile device 400, and a web server 500. The devices 210, 310, and 400 capable of transmitting and receiving NFC signals are collectively referred to as NFC devices.

Self-checkout or self-payment refers to a method in which a customer scans the NFC tag 210 attached to the product 200 and makes a payment directly by using the NFC mobile device 400 for himself without an intervention of a store clerk. At this time, tagging of the second NFC tag 310 may be essential to check information on the store selling the product 200.

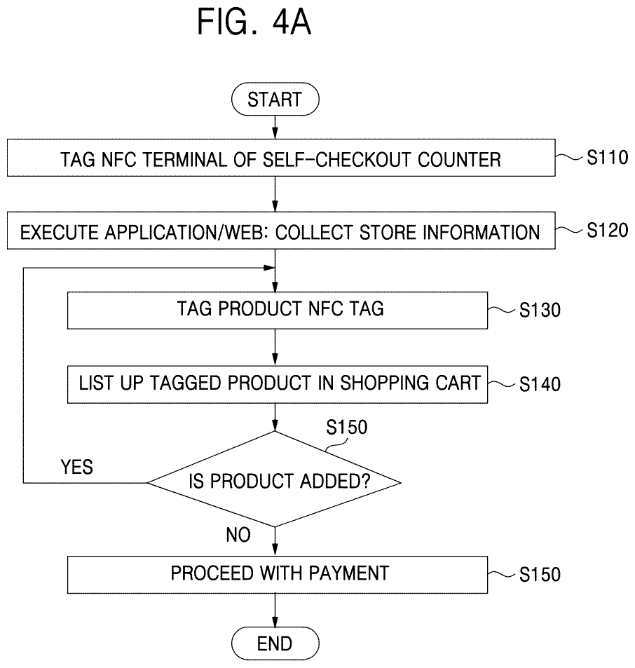

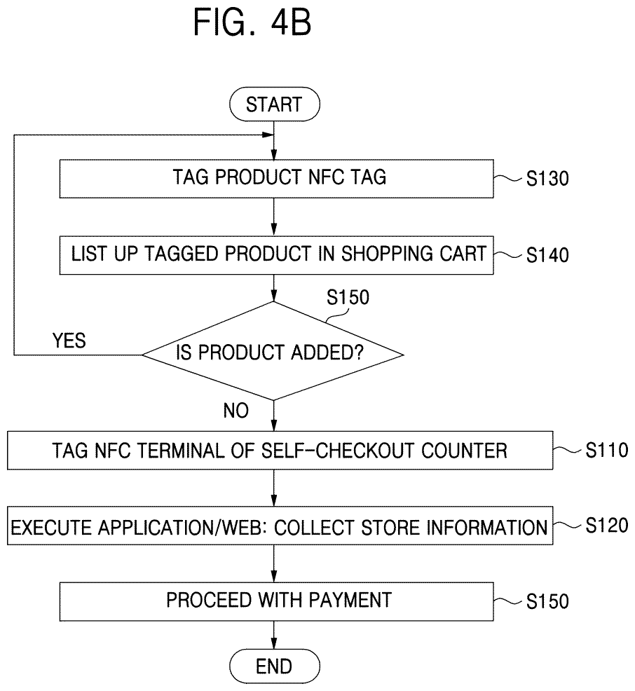

For self-checkout or self-payment, a user of the NFC mobile device 400 can check the information on the store in advance using the second NFC tag 310 as shown in FIG. 4A and then tag the first NFC tag 210 to purchase a product, or as shown in FIG. 4B, tag the first NFC tag 210 first to purchase a product and then tag the second NFC tag 310 to check the information on the store.

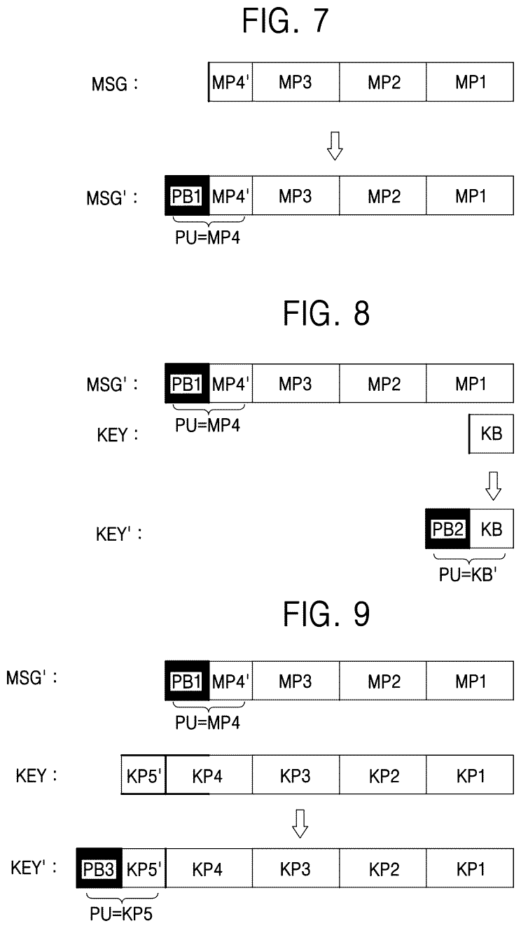

Each of the devices 210, 310, 400, and 500 uses a lightweight ciper-based message authentication code algorithm (LCMAC) proposed in the present invention to generate a message authentication code (MAC) used for message authentication. The LCMAC will be described in detail with reference to FIGS. 7 to 12.

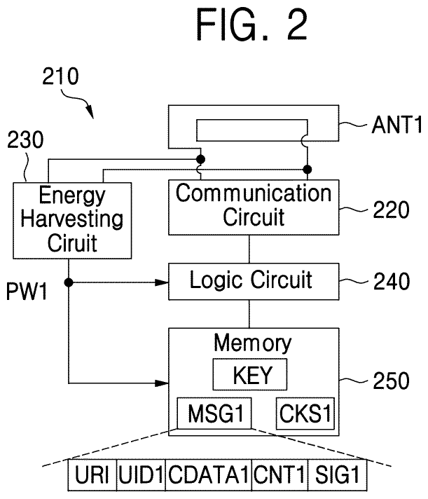

FIG. 2 is a block diagram of the first NFC tag attached to a product shown in FIG. 1. Referring to FIG. 2, the first NFC tag 210 includes a first antenna ANT1, a communication device 220, an energy collection (or harvesting) circuit 230, a logic circuit 240, and a memory 250.

The communication device 220 used as a wireless transceiver demodulates a radio frequency (RF) reception signal transmitted from the first antenna ANT1 to generate a reception signal, transmits the reception signal to the logic circuit 240, modulates a transmission signal transmitted from the logic circuit 240 to generate an RF transmission signal, and transmits the RF transmission signal to the first antenna ANT1.

The energy collection circuit 230 generates a first DC voltage PW1 based on the RF reception signal and supplies the DC voltage PW1 as an operating voltage to each of the logic circuit 240 and the memory 250. For example, the energy collection circuit 230 may include a rectifier that rectifies an RF reception signal and a regulator that regulates an output voltage of the rectifier to generate the first DC voltage PW1.

The logic circuit 240 used as a digital logic circuit can apply a first key to the reception signal transmitted from the communication device 220 or a message transmitted from the memory 250 to generate a first message authentication code CKS1 and store the code CKS1 in the memory 250. The first MAC CKS1 may mean a first checksum.

The process of generating the first MAC CKS1 using the lightweight ciper-based message authentication code algorithm (LCMAC) proposed in the present invention will be described in detail with reference to FIGS. 7 to 12. The reception signal transmitted from the communication device 220 or a message stored in the memory 250 is collectively referred to as a first message MSG1.

The first message MSG1 includes information URI related to web address information for accessing the web server 500 or information for executing an application 425 stored in the NFC mobile device 400, a unique identifier UID1 of the first NFC tag 210, product information CDATA1, a count value CNT1 that sequentially increases each time NFC tagging occurs, and a digital signature SIG1 of an issuer of the first NFC tag 210.

The product information CDATA1 may include information on a manufacturer of the product 200, and/or the serial number (or a product code). The count value CNT1 may be replaced with a random number generated by a random number generator (RNG).

According to embodiments, the logic circuit 240 may include a counter that generates the count value CNT1 or an RNG, may increase the count value CNT1 or generate a random number each time NFC tagging occurs, and may generate a first message MSG1 including the count value CNT1 or the random number to store it in the memory 250.

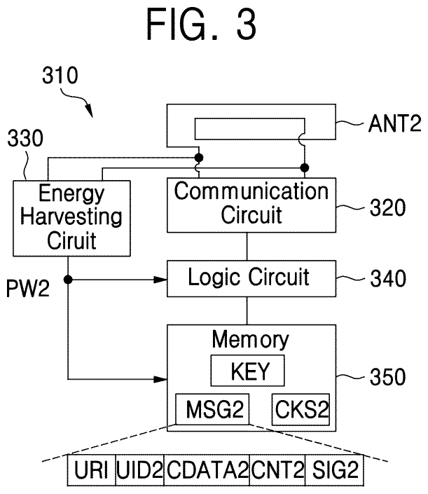

FIG. 3 is a block diagram of the second NFC tag installed in the store shown in FIG. 1. Referring to FIG. 3, the second NFC tag 310 includes a second antenna ANT2, a communication device 320, an energy collection (or harvesting) circuit 330, a logic circuit 340, and a memory 350.

The communication device 320 used as a wireless transceiver demodulates an RF reception signal transmitted from the second antenna ANT2 to generate a reception signal, transmits the reception signal to the logic circuit 340, modulates a transmission signal transmitted from the logic circuit 340 to generate an RF transmission signal, and transmits the RF transmission signal to the second antenna ANT2.

The energy collection circuit 330 generates a second DC voltage PW2 based on the RF reception signal and supplies the DC voltage PW2 as an operating voltage to each of the logic circuit 340 and the memory 350. For example, the energy collection circuit 330 may include a rectifier that rectifies an RF reception signal and a regulator that regulates an output voltage of the rectifier to generate the second DC voltage PW2. The regulator may be a DC-DC converter or a low dropout regulator LD0.

The logic circuit 340 used as a digital logic circuit can apply a second key KEY identical to the first key KEY to the reception signal transmitted from the communication circuit 320 or a message transmitted from the memory 350 to generate a second MAC CKS2 and store it (CKS2) in the memory 350. The second MAC CKS2 may mean a second checksum.

The process of generating the second MAC CKS2 using the LCMAC proposed in the present invention will be described in detail with reference to FIGS. 7 to 12. The reception signal transmitted from the communication circuit 320 or a message stored in the memory 350 is collectively referred to as a second message MSG2.

The second message MSG2 includes information URI related to web address information for accessing the web server 500 or information for executing the application 425 stored in the NFC mobile device 400, a unique identifier UID2 of the second NFC tag 310, store information CDATA2, a count value CNT2 that sequentially increases each time NFC tagging occurs, and a digital signature SIG2 of an issuer of the second NFC tag 310.

The store information CDATA2 may include information (or store code) on the store selling the product 200. The count value CNT2 may be replaced with a random number generated by the RNG. The information on the store may include a name, an address, or a phone number of the store.

According to embodiments, the logic circuit 340 may include a counter that generates a count value CNT2 or RNG, may increase the count value CNT2 or generate a random number each time NFC tagging occurs, and may generate a second message MSG2 including the count value CNT2 or the random number to store it in the memory 350.

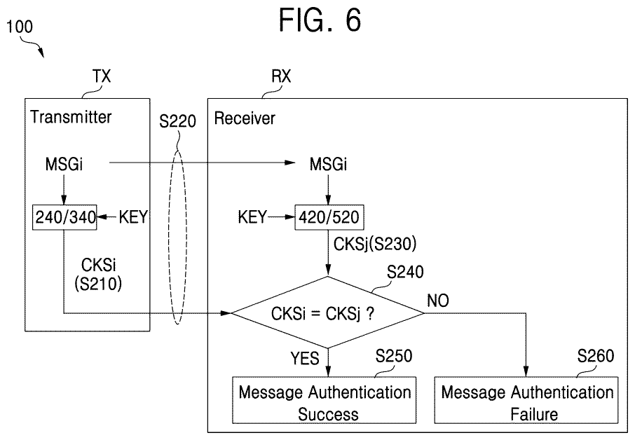

FIG. 6 is a conceptual diagram for describing a method of authenticating a message of a transmitter using the receiver shown in FIG. 1. Referring to FIG. 1 and FIG. 6, a transmitter TX that transmits an NFC signal may be the first NFC tag 210 or the second NFC tag 310, and a receiver RX that receives the NFC signal may be the NFC mobile device 400 or the web server 500. For example, the NFC mobile device 400 may mean an NFC reader and may be a smartphone.

The NFC signal includes the first message MSG1 and the first MAC CKS1 generated by the first NFC tag 210, and the second message MSG2 and the second MAC CKS2 generated by the second NFC tag 310.

When the NFC self-checkout system 100 includes the first NFC tag 210, the second NFC tag 310, the NFC mobile device 400, and the web server 500, the transmitter TX may be the first NFC tag 210 or the second NFC tag 310, and the receiver RX may be the web server 500. At this time, the NFC mobile device 400 may be a device that executes a program 425 for NFC self-checkout.

FIG. 7 is a conceptual diagram for describing a process of generating a correction message by inserting first padding bits into a message. Each logic circuit 240 or 340 included in the transmitter TX, for example, each NFC tag 210 or 310, determines whether a length of an original message MSG is an integer multiple of a processing unit PU.

When the length of the original message MSG is not m-times the processing unit, each logic circuit 240 or 340 generates a correction message MSG′ including m-processing units by inserting the first padding bits PB1 into the original message MSG so that the length of the original message MSG becomes m-times the processing unit PU. Here, m may be a natural number equal to or greater than one.

For the convenience of the following description, it is assumed that the processing unit PU is k bits (for example, k is a natural number equal to or greater than two, hereinafter 16 bits).

Referring to FIG. 7, when each of parts MP1 to MP3 is 16 bits and a fourth part MP4′ is 8 bits, the length of the original message MSG, i.e., MSG1 or MSG2, is 56 bits. Each logic circuit 240 or 340 generates a 16-bit processing unit PU, i.e., MP4, by inserting (or padding) the first padding bits, for example, 8 bits (e.g., 10101010), in front of the fourth part MP4′.

A 64-bit correction message MSG′ including four processing units MP1 to MP4 is generated, and each of the four processing units MP1 to MP4 is 16 bits.

FIG. 8 is a conceptual diagram for describing a process of generating a correction key by inserting second padding bits into a key. As shown in FIG. 8, a length of an original key KEY is shorter than the length of the original message MSG, i.e., MSG1 or MSG2.

When the length of the original key KEY is not n-times the processing unit PU, each logic circuit 240 or 340 generates a correction key KEY′ by inserting second padding bits PB2 into the original key KEY so that the length of the original key KEY becomes n-times the processing unit PU. Here, n may be a natural number equal to or greater than one.

Referring to FIG. 8, when the length of the original key KEY, i.e., KB, is 8 bits, each logic circuit 240 or 340 inserts second padding bits, for example, 8 bits (e.g., 8'b10101010), in front of the first part KB to generate a 16-bit processing unit PU, i.e., KB′.

FIG. 9 is a conceptual diagram for describing a process of generating a correction key by inserting third padding bits into a key when a length of the key is longer than a length of a correction message. As shown in FIG. 9, the length of the original key KEY is longer than the length of the original message MSG, i.e., MSG1 or MSG2.

When the length of the original key KEY is not n-times the processing unit PU, each logic circuit 240 or 340 generates a correction key KEY′ that includes n-processing units by inserting third padding bits PB3 into the original key KEY so that the length of the original key KEY is n-times the processing unit PU.

Referring to FIG. 9, when each of parts KP1 to KP4 is 16 bits and a fifth part KP5′ is 8 bits, the length of the original key KEY is 72 bits. Each logic circuit 240 or 340 inserts third padding bits, for example, 8 bits (for example, 8′10101010), in front of the fifth part KP5′ to generate a 16-bit processing unit PU, i.e., KP5. Accordingly, each of the five processing units KP1 to KP5 is 16 bits.

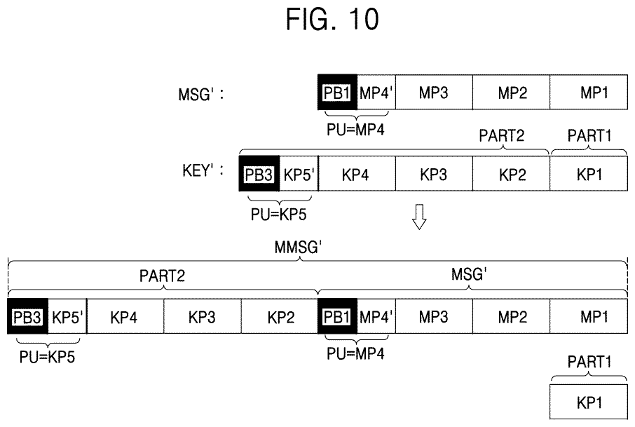

FIG. 10 is a conceptual diagram for describing a process of generating a merged message by merging a portion of the correction key into the correction message.

After the correction message MSG′ and the correction key KEY′ are generated, each logic circuit 240 or 340 divides the correction key KEY′ into a first part PART1 and a second part PART2.

The first part PART1 is a first processing unit (or a lowest processing unit) KP1 among the five processing units KP1 to KP5, and a second part PART2 includes four processing units KP2 to KP5 except for the first processing unit KP1 among the five processing units KP1 to KP5.

Each logic circuit 240 or 340 merges the second part PART2, including, for example, (n−1) processing units, in front of the correction message MSG′, including, for example, m-processing units, to generate a merged message MMSG′ including (m+n−1), for example, eight processing units.

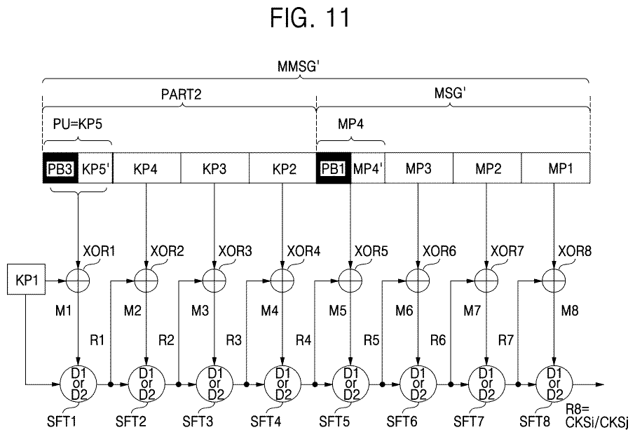

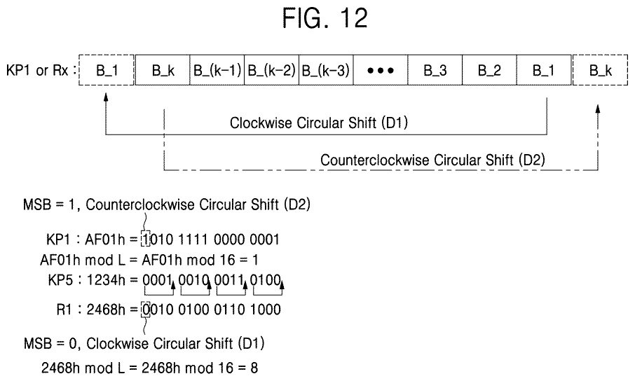

FIG. 11 is a conceptual diagram for describing a process of generating an MAC by the transmitter or receiver of FIG. 6, and FIG. 12 is a conceptual diagram for describing a shift direction and the number of shifts used in the process of generating an MAC in FIG. 11. It is assumed that a corresponding key KP1 or Rx is k bits, i.e., 16 bits. At this time, x is a natural number, and is one of 1 to 8.

Each logic circuit 240 or 340 of each of the NFC tags 210 and 310 that can be used as th transmitter TX includes hardwares for generating an MAC CKSi, where i is 1 or 2, using the LCMAC. For example, the hardware may include a plurality of XOR circuits XOR1 to XOR8 and a plurality of circular shift circuits SFT1 to SFT8, and each of the circular shift circuits SFT1 to SFT8 may perform a clockwise circular shift operation or a counterclockwise circular shift operation depending on a most significant bit MSB value of a corresponding processing unit matching key KP1 and R1 to R7. Although eight XOR circuits and eight circular shift circuits are shown in FIG. 11, this is only an example.

For example, when the MSB value of each processing unit matching key KP1, and R1 t R7 is 0, each of the circular shift circuits SFT1 to SFT8 performs a clockwise circular shift operation D1, and when the MSB value of each processing unit matching key KP1, and R1 to R7 is 1, each of the circular shift circuits SFT1 to SFT8 performs a counterclockwise circular shift operation D2.

For example, a one-time clockwise circular shift operation D1 may mean an operation that converts 1,2,3,4,5,6,7,8 into 8,1,2,3,4,5,6,7. In addition, a one-time counterclockwise circular shift operation D2 may mean an operation that converts 1,2,3,4,5,6,7,8 into 2,3,4,5,6,7,8,1.

A first XOR circuit XOR1 performs a bitwise operation on the first part PART1, i.e., KP1, and a highest processing unit KP5 among the (m+n−1), for example, eight processing units, to generate first operation bits M1 and transmit them (M1) to the first circular shift circuit SFT1.

The first circular shift circuit SFT1 determines whether to perform a clockwise circular shift operation D1 or a counterclockwise circular shift operation D2 on the first operation bits M1 on the basis of the MSB value of the first part PART1, i.e., KP1.

For example, when the first part KP1 is AF01h, i.e., 1010 1111 0000 0001 in binary, the MSB value of the first part KP1 is 1, so that the first circular shift circuit SFT1 performs the counterclockwise circular shift operation D2 on the first operation bits M1.

The first circular shift circuit SFT1 performs a modulo-operation on a bit value (for example, AF01h) corresponding to the first part KP1 using a natural number (e.g., 16) corresponding to a length of the first part KP1 to determine the number of shifts according to Equation 1.

$$AF 01 h mod 16 = 1 \qquad [ Equation 1 ]$$

The first circular shift circuit SFT1 performs a one-time counterclockwise circular shift operation D2 on the first operation bits M1.

When a (m+n−1)^{th}, for example, an 8^{th} processing unit KP5 of the merged message MMSG′ is 1234h, i.e., 0001 0010 0011 0100 in binary, the first circular shift circuit SFT1 performs a one-time counterclockwise circular shift operation on the 8^{th} processing unit (KP5, 1234h) according to a shift direction and the number of shifts determined based on the first part (KP1, AF01h).

Therefore, the first circular shift circuit SFT1 outputs the first operation bits (R1=2468h), i.e., 0010 0100 0110 1000 in binary, for 1234h, i.e., 0001 0010 0011 0100 in binary, to a second XOR circuit XOR2 and a second circular shift circuit SFT2.

The second XOR circuit XOR2 performs a bitwise operation on the first operation bits (R1=2468h) of the first circular shift circuit SFT1 and a seventh processing unit KP4 to generate second operation bits M2.

The second circular shift circuit SFT2 determines whether to perform a clockwise circular shift operation or a counterclockwise circular shift operation on the second operation bits M2 on the basis of an MSB value of the first operation bits (R1=2468h).

For example, since the MSB value of the first operation bits (R1=2468h) is 0, the second circular shift circuit SFT2 performs a clockwise circular shift operation on the second operation bits M2.

In addition, the second circular shift circuit SFT2 performs a modulo-operation on the first operation bits (R1=2468h) using a natural number (e.g., 16) corresponding to a length of the first operation bits (R1=2468h) to determine the number of shifts according to Equation 2.

$$2468 h mod 16 = 8 \qquad [ Equation 2 ]$$

The second circular shift circuit SFT2 performs an eight-time clockwise circular shift operation D1 on the second operation bits M2 of the second XOR circuit XOR2, generates second shift bits R2, and outputs them to a third XOR circuit XOR3 and a third circular shift circuit SFT3.

An operation of each XOR circuit XOR3 to XOR7 is the same as that of each XOR circuit XOR1 and XOR2 already described. In addition, since an operation of each circular shift circuit SFT3 to SFT7 is the same as that of each circular shift circuit SFT1 and SFT2 already described, a detailed description thereof will be omitted.

Each circular shift circuit SFT3 to SFT7 determines a shift direction according to an MBS value of each shift bit R2 to R6, and determines the number of shifts as many as a natural number value corresponding to the last 4 bits (e.g., 4 bits expressed in binary) of each shift bit R2 to R6.

An 8^{th} XOR circuit XOR8 performs a bitwise XOR operation on 7^{th} shift bits R7 and a lowest processing unit MP1 to generate 8^{th} operation bits, e.g., lowest operation bits M8.

An 8^{th} circular shift circuit SFT8 determines the number of shifts as many as a natural number value corresponding to an MSB value of the 7th shift bits R7 and last 4 bits (e.g., 4 bits expressed in binary) of the 7^{th} shift bits R7.

The 8th circular shift circuit SFT8 applies the determined shift direction and the number o shifts to the lowest operation bits M8 to generate 8^{th} shift bits R8 and store them in the memory 250 or 350. The 8^{th} shift bits R8 may be an MAC (CKS1 or CKS2).

When the logic circuit 240 of the first NFC tag 210 generates a packet including the first message MSG1 and the first MAC CKS1 and outputs the packet to the communication circuit 220, the communication circuit 220 converts the packet according to an NFC protocol and outputs a converted NFC signal RFD through the first antenna ANT1.

When the logic circuit 340 of the second NFC tag 310 generates a packet including the second message MSG2 and the second MAC CKS2 and outputs the packet to the communication circuit 320, the communication circuit 320 converts the packet according to the NFC protocol and outputs the converted NFC signal RFD through the second antenna ANT2.

Each processor 420 or 520 of each device 400 or 500 that can be used as a receiver RX includes hardwares for generating an MAC described with reference to FIGS. 11 and 12. For example, the hardware includes the plurality of XOR circuits XOR1 to XOR8 and the plurality of circular shift circuits SFT1 to SFT8.

According to the embodiments, each processor 420 or 520 of each device 400 or 500 may include software for generating the MAC described with reference to FIGS. 11 and 12.

FIG. 4A is a flowchart for describing NFC self-checkout methods performed using the NFC system shown in FIG. 1. Referring to FIGS. 1 to 12, the transmitter TX applies a correction key (KEY′) for the transmitter TX to a message MSGi as described with reference to FIGS. 7 to 12 to generate an MAC CKSi (S210).

The transmitter TX generates an NFC signal DATA including the message MSGi and the MAC CKSi in response to NFC tagging of the receiver RX and transmits it to the receiver RX (S220). The receiver RX receives the NFC signal DATA and generates an MAC CKSj by applying a correction key KEY′ for the receiver RX to the received message MSGi as described with reference to FIGS. 7 to 12 (S230).

The receiver RX compares the received MAC CKSi with the generated MAC CKSj (S240), and when the received MAC CKSi and the generated MAC CKSj are identical (YES in S240), it is determined that authentication for the received message MSGi is successful (S250), and when the received MAC CKSi and the generated MAC CKSj are not identical (NO in S240), it is determined that the authentication for the received message MSGi is failed (S260). When it is determined that the authentication for the received message MSGi is successful, the transmitter TX and the receiver RX may exchange NFC signals.

An NFC system 100 capable of performing an NFC self-checkout method includes the first NFC tag 210, the second NFC tag 310, the NFC mobile device 400, and the web server 500.

The first NFC tag 210 stores the first key KEY, the first message MSG1, and the first MAC CKS1. The second NFC tag 310 stores the second key KEY identical to the first key KEY, the second message MSG2, and the second MAC CKS2. The NFC mobile device 400 includes a processor 420 that executes a shopping cart program 425 for NFC self-checkout, and the web server 500 stores a fourth key KEY identical to the first key KEY. At this time, each NFC tag 210 and 310 performs a function of the transmitter TX, and the web server 500 performs a function of the receiver RX.

Referring to FIG. 4A, after the second NFC tag 310 is tagged by the NFC mobile device 400 for NFC self-checkout (S110), when the web server 500 determines that the authentication for the received message MSG2 is successful, the NFC mobile device 400 executes the shopping cart program 425 in response to control of the web server 500, for example, an authentication success message (S120).

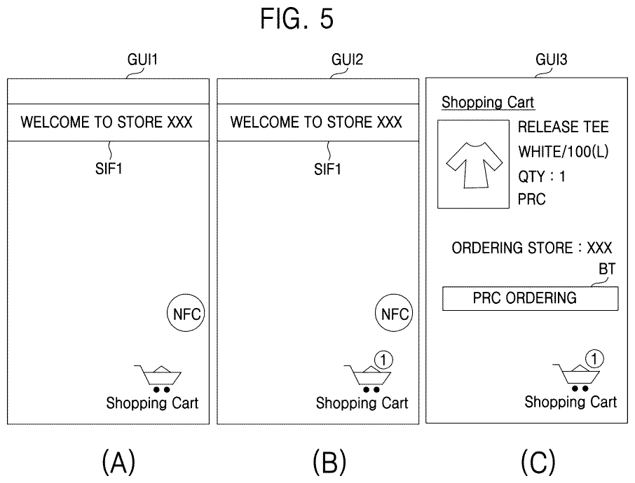

As the shopping cart program 425 is executed, a first graphical user interface GUI1 as in (A) of FIG. 5 is displayed on a display device 440. At this time, the first graphical user interface GUI1 includes store information CDATA2 and a shopping cart. The store information CDATA2 may be displayed as ‘Welcome to the store XXX (e.g., a store name)’(SIF1).

When the first NFC tag 210 is tagged by the NFC mobile device 400 for NFC self-checkout (S130), the first NFC tag 210 transmits an NFC signal DATA including the first message MSG1 and the first MAC CKS1 to the NFC mobile device 400 in response to an NFC signal transmission request.

The NFC mobile device 400 transmits the NFC signal DATA including the first message MSG1 and the first MAC CKS1 to the web server 500.

The web server 500 receives the NFC signal DATA and applies the correction key KEY′ generated by the web server 500 to the first message MSG1 as described with reference to FIGS. 7 to 12 to generate an MAC CKSj.

The web server 500 compares the received first MAC CKS1 with the generated MAC CKSj, and when the received first MAC CKS1 and the generated MAC CKSj are identical (YES in S240), it determines that authentication for the received first message MSG1 is successful.

When the web server 500 determines that the authentication for the first message MSG1 is successful, the NFC mobile device 400 lists up products tagged in step (S130) as shown in (B) of FIG. 5 in the shopping cart in the shopping cart program 425 in response to the control of the web server 500, for example, the authentication success message (S140).

When there is no product to add (NO in S150), the user of the NFC mobile device 400 checks the shopping cart as shown in (C) of FIG. 5 and then clicks a button BT for NFC self-checkout, the shopping cart program 425 transmits product information on a product to be purchased by the user and payment information to the web server 500 (S150). The payment information includes a product price (PRC) and payment method information (e.g., credit card information, debit card information, or bank information).

When there is a product to add (YES in S150), the user of the NFC mobile device 400 performs the step (S130) of tagging an NFC tag attached to another product. At this time, a structure of the NFC tag is the same as a structure of the first NFC tag 210.

FIG. 4B is a flowchart for describing NFC self-checkout methods performed using the NFC system shown in FIG. 1.

FIG. 4A shows steps in which the second NFC tag 310 attached to the self-checkout counter 300 is NFC-tagged by the NFC mobile device 400, and then the first NFC tag 210 attached to the product 200 is NFC-tagged by the NFC mobile device 400. However, FIG. 4B shows steps in which the first NFC tag 210 attached to the product 200 is NFC-tagged by the NFC mobile device 400, and then the second NFC tag 310 attached to the self-checkout counter 300 is NFC-tagged by the NFC mobile device 400.

As described with reference to FIGS. 1 to 12, the transmitter TX generates a first MAC for a first message (e.g., a message to be transmitted), stores it in a memory, and then transmits an NFC signal including the first message and the first MAC to the receiver RX in response to a request from the receiver RX, for example, NFC tagging.

The receiver RX receives the NFC signal including the first message and the first MAC, applies the correction key KEY′ generated using the key KEY of the receiver RX to the received first message to generate a second MAC, compares the first MAC with the second MAC, determines that authentication for the first message is successful when the first MAC and the second MAC are identical, and allows interaction with the transmitter TX when the authentication is successful.

The NFC tag and NFC reader according to the embodiment of the present invention have an effect of being able to authenticate a received message by performing simple operations, such as an XOR operation, a circular shift operation, and a modulo operation, instead of using an AES algorithm or DES algorithm.

The NFC tag and NFC reader according to the embodiment of the present invention have an effect of being able to quickly authenticate a received message with low power by performing the simple operations, such as an XOR operation, a circular shift operation, and a modulo operation.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A Near Field Communication (NFC) tag comprising:
a memory configured to store a message and a key; and
a logic circuit configured to receive the message and the key, and determine whether each of a length of the message and a length of the key is an integer multiple of a processing unit,
wherein the logic circuit configured to:
generate, when the length of the message is not m-times the processing unit, a correction message including m-processing units by inserting first padding bits into the message so that the length of the message becomes m-times the processing unit,
generate, when the length of the key is not n-times the processing unit, a correction key including n-processing units by inserting second padding bits into the key so that the length of the key becomes n-times the processing unit, and
divide the correction key into a first part and a second part,
wherein the processing unit is k bits, each of m and n is a natural number equal to or greater than one, and k is a natural number equal to or greater than two.

2. The NFC tag of claim 1,
wherein the logic circuit configured to generate (m+n−1) processing units by merging the second part and the correction message,
wherein the first part is a lowest processing unit among the n-processing units, and
wherein the second part includes (n−1) processing units.

3. The NFC tag of claim 2,
wherein the logic circuit configures to:
generate operation bits by performing a bitwise XOR operation on the first part and a (m+n−1)^{th} processing unit,
determine a shift direction for the operation bits on the basis of a most significant bit (MSB) value of the first part, and
determine the number of shifts by performing a modulo-operation on a bit value corresponding to the first part using a natural number corresponding to a length of the processing unit,
wherein the shift direction is one of a clockwise circular shift and a counterclockwise circular shift.

4. The NFC tag of claim 3,
wherein the logic circuit configured to generate shift bits by applying the shift direction and the number of shifts to the operation bits.

5. The NFC tag of claim 2,
wherein the logic circuit configured to:
generate lowest operation bits by performing a bitwise XOR operation on a lowest processing unit among the (m+n−1) processing units and a lowest processing unit matching key,
determine a shift direction for the lowest operation bits on the basis of an MSB value of the lowest processing unit matching key,
determine the number of shifts by performing a modulo-operation on the bit value corresponding to the lowest operation bits using a natural number corresponding to the length of the processing unit, and
generate a message authentication code (MAC) by applying the shift direction and the number of shifts to the lowest operation bits,
wherein the shift direction is one of a clockwise circular shift and a counterclockwise circular shift.

6. The NFC tag of claim 5, further comprising:
an antenna; and
a communication circuit connected to the antenna,
wherein the logic circuit configured to transmit a data packet including the message and the MAC to the communication circuit,
wherein the communication circuit configured to convert the data packet into an NFC signal and transmits the NFC signal to the antenna.

7. A Near Field Communication (NFC) reader comprising:
a memory configured to store a key;
an antenna configured to receive a message and a first message authentication code (MAC) transmitted from an NFC tag;
a communication circuit configured to receive the message and the first MAC from the antenna; and
a processor configured to receive the message and the key and determine whether each of a length of the message and a length of the key is an integer multiple of a processing unit,
wherein the processor configured to:
generate, when the length of the message is not m-times the processing unit, a correction message including m-processing units by inserting first padding bits into the message so that the length of the message becomes m-times the processing unit,
generate, when the length of the key is not n-times the processing unit, a correction key including n-processing units by inserting second padding bits into the key so that the length of the key becomes n-times the processing unit, and
divide the correction key into a first part and a second part,
wherein the processing unit is k bits, each of m and n is a natural number equal to or greater than one, and k is a natural number equal to or greater than two.

8. The NFC reader of claim 7,
wherein the processor configured to generate (m+n−1) processing units by merging the second part and the correction message,
wherein the first part is a lowest processing unit among the n-processing units, and
wherein the second part includes (n−1) processing units.

9. The NFC reader of claim 8,
wherein the processor configured to:
generate lowest operation bits by performing a bitwise XOR operation on a lowest processing unit among the (m+n−1) processing units and a lowest processing unit matching key,
determine a shift direction for the lowest operation bits on the basis of a most significant bit (MSB) value of the lowest processing unit matching key,
determine the number of shifts by performing a modulo-operation on a bit value corresponding to the lowest processing unit using a natural number corresponding to a length of the processing unit, and
generate a second MAC by applying the shift direction and the number of shifts to the lowest operation bits,
wherein the shift direction is one of a clockwise circular shift and a counterclockwise circular shift.

10. The NFC reader of claim 9,
wherein the processor configured to:
compare the first MAC and the second MAC,
determine that authentication for the message is successful when the first MAC and the second MAC are identical, and
determine that authentication for the message is failed when the first MAC and the second MAC are not identical.

11. A method of authenticating a message of a Near Field Communication (NFC) tag using an NFC reader storing a key, comprising:
receiving, by the NFC reader, the message and a first message authentication code (MAC) from the NFC tag when the NFC tag is tagged by the NFC reader;
generating, by the NFC reader, a correction message including m-processing units by inserting first padding bits into the message so that a length of the message becomes m-times the processing unit;
generating, by the NFC reader, a correction key including n-processing units by inserting second padding bits into the key so that a length of the key becomes n-times the processing unit;
and dividing, by the NFC reader, the correction key into a first part and a second part,
wherein the processing unit is k bits, each of m and n is a natural number equal to or greater than one, and k is a natural number equal to or greater than two.

12. The method of claim 11, further comprising:
generating, by the NFC reader, (m+n—1) processing units by merging the second part and the correction message,
wherein the first part is a lowest processing unit among the n-processing units, and
wherein the second part includes (n−1) processing units.

13. The method of claim 12, further comprising:
generating, by the NFC reader, lowest operation bits by performing a bitwise XOR operation on a lowest processing unit among the (m+n−1) processing units and a lowest processing unit matching key;
determining, by the NFC reader, a shift direction for the lowest operation bits on the basis of a most significant bit (MSB) value of the lowest processing unit matching key;
determining, by the NFC reader, the number of shifts by performing a modulo-operation on a bit value corresponding to the lowest processing unit using a natural number corresponding to a length of the processing unit; and
generating, by the NFC reader, a second MAC by applying the shift direction and the number of shifts to the lowest operation bits,
wherein the shift direction is one of a clockwise circular shift and a counterclockwise circular shift.

14. The method of claim 13, further comprising:
comparing, by the NFC reader, the first MAC and the second MAC; and
determining that authentication of the message is successful when the first MAC and the second MAC are identical.

15. The method of claim 11,
wherein the message includes:
at least one of web address information for accessing a web server or execution information on an application included in the NFC reader;
at least one of product information or store information;
a count value that sequentially increases each time the NFC tag is tagged by the NFC reader, and
a digital signature.

16. A Near Field Communication (NFC) self-checkout method using an NFC system,
wherein the NFC system includes:
a first NFC tag configured to store a first key, a first message, and a first message authentication code (MAC) and is attached to a product,
a second NFC tag configured to store a second key identical to the first key, a second message, and a second MAC, and is installed in a store,
an NFC mobile device that includes a processor configured to execute a shopping cart program for NFC self-checkout; and
a web server configured to store a third key identical to the first key,
wherein the NFC self-checkout method includes:
receiving, by the NFC mobile device, the second message including a web address corresponding to the web server and store information and the second MAC from the second NFC tag and transmitting the second message and the second MAC to the web server when the second NFC tag is tagged by the NFC mobile device;
generating, by the web server, a third MAC by applying the third key to the second message;
comparing, by the web server, the second MAC and the third MAC; and
controlling, by the web server, the NFC mobile device so that the shopping cart program is executed when the second MAC and the third MAC are identical.

17. The NFC self-checkout method of claim 16,
wherein the generating a third MAC includes:
generating, by the web server, a correction message including m-processing units by inserting first padding bits into the second message so that a length of the second message becomes m-times a processing unit,
generating, by the web server, a correction key including n-processing units by inserting second padding bits into the second key so that a length of the second key is n-times the processing unit, and
dividing, by the web server, the correction key into a first part and a second part,
wherein the processing unit is k bits, each of m and n is a natural number equal to or greater than one, and k is a natural number equal to or greater than two.

18. The NFC self-checkout method of claim 17,
wherein the generating a third MAC further includes:
generating, by the web server, (m+n−1) processing units by merging the second part and the correction message,
wherein the first part is a lowest processing unit among the n processing units, and
wherein the second part includes (n−1) processing units.

19. The NFC self-checkout method of claim 18,
wherein the generating a third MAC further includes:
generating, by the web server, lowest operation bits by performing a bitwise XOR operation on a lowest processing unit among the (m+n−1) processing units and a lowest processing unit matching key;
determining, by the web server, a shift direction for the lowest operation bits on the basis of a most significant bit (MSB) value of the lowest processing unit matching key;
determining, by the web server, the number of shifts by performing a modulo-operation on a bit value corresponding to the lowest processing unit using a natural number corresponding to a length of the processing unit; and
generating, by the web server, the third MAC by applying the shift direction and the number of shifts to the lowest operation bits,
wherein the shift direction is one of a clockwise circular shift and a counterclockwise circular shift.

20. The NFC self-checkout method of claim 19, further comprising:
receiving, by the NFC mobile device, the first message including the web address and product information and the first MAC from the first NFC tag and transmitting the first message and the first MAC to the web server when the first NFC tag is tagged by the NFC mobile device;
generating, by the web server, a fourth MAC by applying the third key to the first message;
comparing, by the web server, the first MAC and the fourth MAC, controlling the NFC mobile device so that the shopping cart program lists up the product information in a shopping cart when the first MAC and the fourth MAC are identical; and
transmitting, by the shopping cart program, the product information and payment information to the web server.
